(19) United States
(12) Patent Application Publication
(10) Pub. No.: US 2014/0304340 A1
(43) Pub. Date: Oct. 9, 2014

(54) SYSTEM AND METHOD TO BREAK COMMUNICATION THREADS

(71) Applicant: INTERNATIONAL BUSINESS MACHINES CORPORATION, Armonk, NY (US)

(72) Inventors: Lisa Seacat DeLuca, Baltimore, MD (US); Geetika T. Lakshmanan, Winchester, MA (US); Michael Muller, Medford, MA (US)

(73) Assignee: International Business Machines Corporation, Armonk, NY (US)

(21) Appl. No.: 13/858,496

(22) Filed: Apr. 8, 2013

(51) Int. Cl. H04L 12/58

(52) U.S. Cl. CPC H04L 51/16
USPC 709/206

(57) ABSTRACT

A method and system for breaking a communications thread on a communications system includes monitoring a communications system having a plurality of users. An initial communications thread is identified between two or more of the plurality of users on the communications system. The initial communications thread is broken based on a criteria. The criteria includes a user initiated break wherein a user selectively breaks the initial communications thread. New communications threads are generated from the break in the initial communications thread which include, a first thread including communications before the break and a second thread including communications after the break. A link may be generated in each of the first and second threads referring to the other thread such that the initial communications thread is reconstituted when either of the links are selected.

### FIELD

The present disclosure relates to a method and system for breaking a communications thread between users on a communications system.

### BACKGROUND

Communicative exchanges by multiple users using a communications network can include extensive conversations, for example, via email or text messaging. Users may communicate via electronic messaging which may be accessible by a computer or personal data assistant (PDA), and further may communicate using, on-line chat groups, blogs, e-mails, instant messaging between users, document libraries, and social networking websites accessible using the Internet. Messaging Applications such as Instant Messaging and group messaging are numerous on computing devices. Email is also extensively used via the Internet or using an Intranet. The use of multiple clients, for example, mobile phones, tablets, laptops, netbooks, car communication systems, etc., is also growing.

Messaging communications systems 50 may include the Internet 52, or a public switched telephone network (PSTN) 54, which further may include telephone lines, fiber optic cables, microwave transmission links, cellular networks, communications satellites, and undersea telephone cables. Exemplary messaging clients/messaging services may include Short Message Service (SMS) which is a text messaging service component of phone, web, or mobile communication systems, using standardized communications protocols which allows the

exchange of short text messages between fixed line or mobile phone devices. The Internet may facilitate numerous texting techniques, for example, using a cell phone or laptop computer to send text messages via Multimedia Messaging Service (MMS) (related to SMS) as one way to send messages that include multimedia content to and from mobile phones, or to and from one or more email accounts via the Internet.

However, for example, typical users may respond to a set of individuals copied in an email exchange because it is easier to reply to all users then to start a new thread, and/or parse through participants. This can lead to an undesirably large email thread. Large email threads or text messaging threads are undesirable at least in part because they are cumbersome to navigate, less likely to communicate important information, and require more storage space. Furthermore, a message thread may include many topics, some of which are unrelated because users continue to add to the thread and send to other users. Thereby, unwieldy messaging threads are created that can be cumbersome to read, understand, and communicate useful information.

In one example, a communication thread may be broken based on a subset of the participants. For example, when a new participant is added, break the thread. However, the above example does not allow for other techniques for breaking a thread in different places and the use of different criteria for the thread break.

Therefore, there is a need for a method and system to provide a technique for breaking communication threads, such as emails and text messages, to make threads more manageable and useful for the user.

### BRIEF SUMMARY

In an aspect of the invention, a method for breaking a communications thread on a communications system comprises the steps of: identifying an initial communications thread between two or more of a plurality of users on a communications system; breaking the initial communications thread based on a criteria, the criteria including a user initiated break wherein a user selectively breaks the initial communications thread; generating new communications threads from the break in the initial communications thread which include a first thread including communications before the break and a second thread including communications after the break. At least one of the above steps being performed using a computer.

In a related aspect, the above method further includes, generating a link in each of the first and second threads referring to the other thread such that the initial communications thread is reconstituted when either of the links are selected.

In another aspect of the invention, a system for breaking a communications thread on a communications system includes an initial communications thread between two or more of a plurality of users on a communications system which is identifiable by a program embodied on a computer readable storage device and being executable by a processor of a computer. A criteria for breaking the initial communications thread includes a user initiated break wherein a user selectively breaks the initial communications thread. New communications threads are generated from the break in the initial communications thread which include a first thread including communications before the break and a second thread including communications after the break.

In another aspect of the invention a computer program product for breaking a communications thread on a communications system includes a computer readable storage medium having program code embodied therewith. The program code is readable/executable by a processor to perform a method including: identifying an initial communications thread between two or more of a plurality of users on a communications system; breaking the initial communications thread based on a criteria, the criteria including a user initiated break wherein a user selectively breaks the initial communications thread; generating new communications threads from the break in the initial communications thread which include a first thread including communications before the break and a second thread including communications after the break.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is a schematic block diagram illustrating an overview of a system and methodology for breaking a communications thread between users on a communications system;

FIG. 2 is a flow chart illustrating a method for breaking communications threads between users on a communications system according to an embodiment of the disclosure using the system shown in FIG. 1;

FIG. 3 is a flow chart illustrating an optional method continuing from the method shown in FIG. 2; and

FIG. 4 is a flow chart illustrating an optional method continuing from the method shown in FIG. 2.

### DETAILED DESCRIPTION

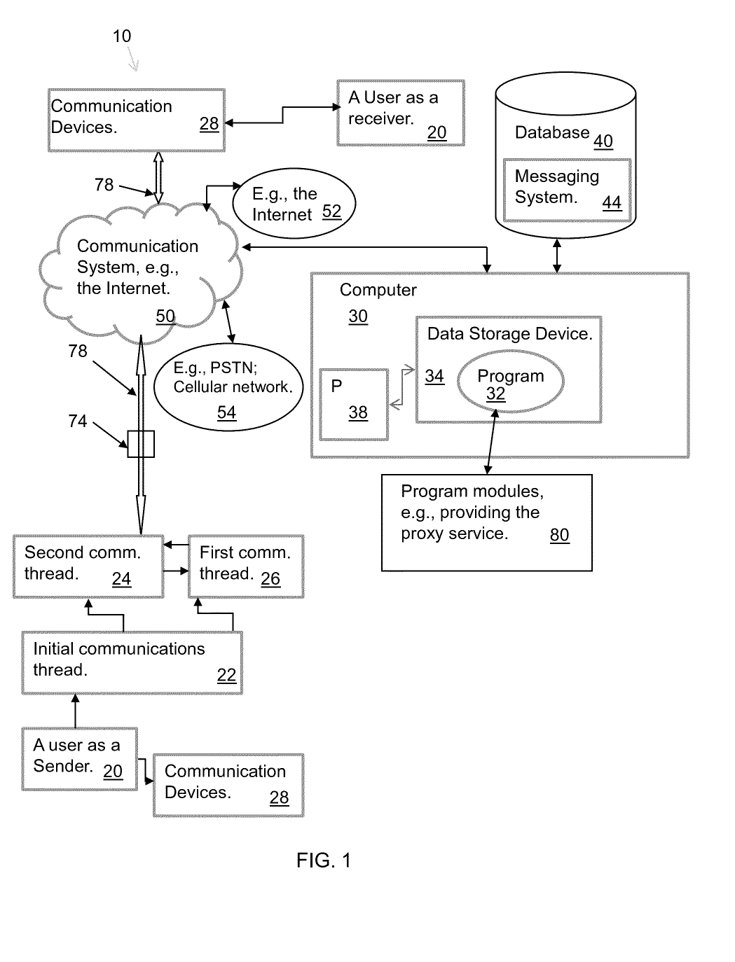

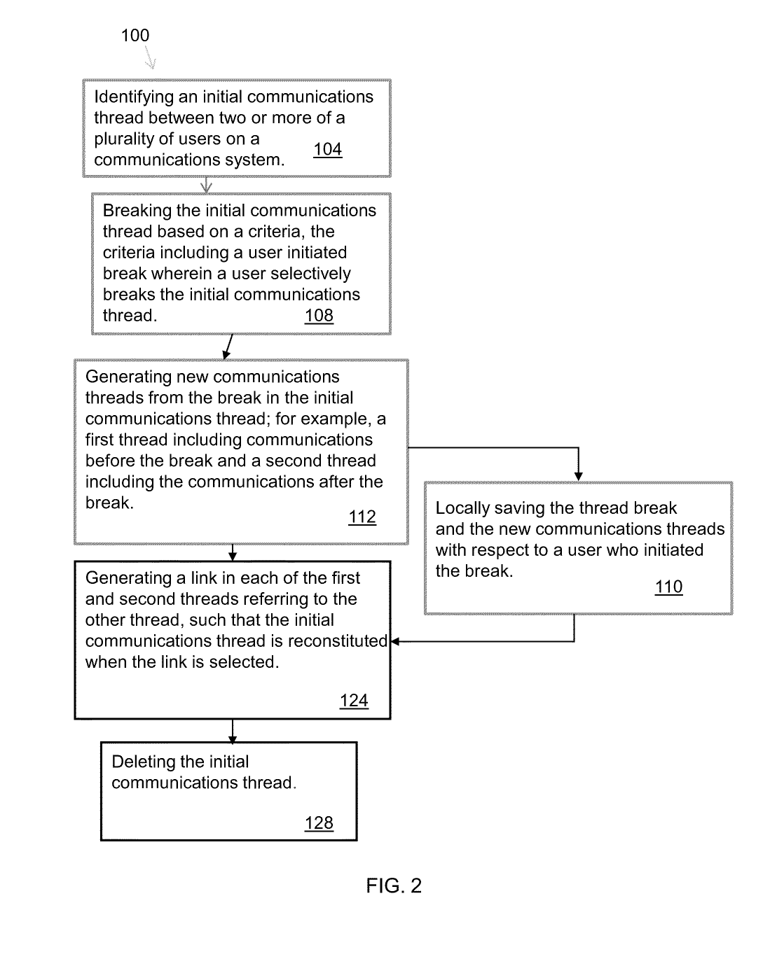

Referring to FIGS. 1 and 2, according to an embodiment of the invention, a system 10 and method 100 for breaking a communications thread on a communications system is used by a plurality of user 20. A communication system 50 may include the Internet 52, or a public switched telephone network (PSTN) 54, which further may include telephone lines, fiber optic cables, microwave transmission links, cellular networks, and communications satellites. Exemplary messaging services may include Short Message Service (SMS) or the Internet as techniques to send messages that include multimedia content to and from mobile phones, or to and from one or more email accounts via the Internet.

A messaging system 44 may communicate and be stored on a data storage device such as a database 40. An initial communications thread is identified between users, using a program 32 embodied on a computer readable storage device that is executable by a processor of a computer 30, as in step 104 of the method 100. The electronic communications or communications thread may also be referred to as a conversation. The program may be offered as a service by a provider for user communications as part of a cellular service, or Internet service, or an email service. The program may also be stored and run locally on a user device. A computer 30 and program 32 are generically represented in FIG. 1, wherein the program 32 is stored on a data storage device 34 of the computer 30. A processor 38 of the computer can execute the program 32 (i.e., program steps, code, or program code). The program may include program modules 80 for executing specific steps of the program. Such modules 80 are generically represented in FIG. 1.

Generally, communications or communications threads may include emails sent from computer, or messaging conversations (e.g., electronic messaging) which can include data, text, or electronic content, and may require an associated communications service, such as SMS or MMS. Messaging services may be required to enable communication devices (or simply referred to as devices herein), similarly computer and devices using email may use a specific application. Device for electronically communicating between devices and users may use, for example, email or text messaging, and the device may include: a laptop, a notebook, a cell phone, a netbook, a tablet, a personal data assistant (PDA), or a car communication system. The devices are collectively represented as communication devices 28, shown in FIG. 1. In the embodiment of the disclosure of FIG. 1, an initial communications thread 22 is initiated or contributed to by a user 20. In one example, the user has received a message, and the user initiates breaking the initial communications thread 22 before sending a reply message. The break in the communication thread can be based on a criteria wherein the criteria includes a user initiated break, that is, a user selectively breaks the initial communications thread, as in step 108 of the method 100.

In the embodiment of the invention shown in FIG. 2, two new threads are generated at the user initiated break (or alternatively referred to as a break point) in the initial communications thread, as in step 112 of the method 100. The initial communications thread before the break is included in a first communications thread, and the initial communications thread after the break is a second communications thread. Each of the first and second communications threads can have respective links to each other, as in step 124. The first and second links enable a user to reconnect the first and the second threads to re-generate the initial communications thread and view the entire message thread.

The thread break and any new communications threads may be saved locally with respect to a user who initiated the break, as in step 110. Thus, in the method 100, the break in the communications thread (or the thread break) and the new communications threads including the first and second communications threads can be saved locally with respect to the user initiating the thread break.

The initial communications thread may be deleted, as in step 128, but can be regenerated as above. Deleting the initial communications thread saves storage space and also reduces confusion and duplication.

A notification of a break in the communications thread can be sent to other users, for instance, that the initial thread was broken by an initiating user. The notification can also include an option or a break thread option to accept or reject the thread break. Thereby, the method may include presenting a break thread option to another user for acceptance or rejection of the break in an initial communications thread. Thus, each user may have their own thread breaks, saved locally, such that each user views a thread according to their individually selected thread breaks. The thread break option may also be presented to multiple users, and then individually applied to each user according to their acceptance or rejection of the options.

In one instance of the present disclosure, the system and method presents a break thread option to multiple users for acceptance or rejection of the break thread option for the initial communications thread. The break thread option is applied based on a majority vote by the multiple users. The multiple users can select an option for acceptance or rejection of the break thread and the votes tallied for a simple majority determining whether to accept or reject the break thread option. The users thereby initiate a group consensus regarding thread breaks. Alternatively, the users in a conversation may always accept thread breaks from one or more of the users. Also, a user may only accept thread breaks from designated users, such as users that are designated as friends in a social forum.

In another instance of the present disclosure, the initial communications thread can be broken automatically based on the criteria. The automatic break can be initiated by the program 32. The automatic break thread option may include breaking the thread at a specified content change, thereby breaking the thread based on the context of the communications.

The criteria may include a plurality of break thread options including breaking the initial thread at a specific message. The criteria may include multiple break thread options, and the method may further include automatically breaking the initial communications thread by selecting one of the break thread options, and presenting the break thread option to a user for acceptance or rejection by the user. The user can select an acceptance or rejection, such as may be presented in a dialog box.

The criteria may also include breaking the initial communications thread based on: a context change of the thread; a change in a recipient of the thread; exceeding a threshold time of the thread; or exceeding a threshold length of the thread. For example, an Email thread may be broken using a criteria which includes a change in subject, or by a time period. In one instance, if a conversation between users continues after a set period of time, e.g., one day, the thread may break when the conversation continues after one day. The method and system of the present disclosure may break the thread according to a criteria including the users, that is, breaking the thread based on the one or more users enter the conversation. Similarly, the thread may be broken when the context changes, for example, the users switch from a first topic to a second topic. In another instance, the thread can be broken when a user is added to the conversation or removed from the conversation. Criteria for an automatic thread break may be specified by users beforehand, and changed by users periodically.

The method and system and examples herein can also be applied to other online communications in addition to email and texting, for example, forums, blogs, and other threaded communication mechanisms.

In an example, an initiating user may select a break point in the initial communications thread for breaking the thread. The thread is then broken at the selected point and two new thread result, one before the break point and one after the break point, which both have links to each other to reestablish the complete thread.

Further, the initiating user may select a break point in the initial communications thread for breaking the thread before sending a new thread based on the initial communications thread to another user.

In another embodiment of the present disclosure, a user sets one or more rules for breaking the initial thread, and another user can accept or reject each of the rules.

Advantages of the present disclosure includes that the communications thread can be separated clearly by topic or context of the messages. The system and method of the present disclosure enables generating a criteria for a new thread, and/or selecting a thread criteria from a set of break thread options.

The method and system of the present disclosure may include, for example, a user interacting with an email client to send emails may decide at any point in the communication that they wish to break the existing communication thread. The initiation of the thread break may be accomplished by the user choosing from menu options to break the thread at a specific message. In another instance, the thread break may be initiated by the user double clicking using a mouse on the spot in the thread where the break should occur. In another example, a new button within the email client may be generated to handle thread breaks. Another example includes presenting an option to a user when the user replies to an email message. The option allows the user to start a new thread, and can prompt the user about keeping the same participants. Once the user has selected a thread break, the break can be saved locally and suggested to other users across a group.

Thereby, referring to FIG. 2, the method 100 according to an embodiment of the disclosure, and using the system 10 as described above, provides a method for breaking a communications thread on a communications system. The method 100 includes the step of identifying an initial communications thread between two or more of a plurality of users on a communications system, in step 104. Step 108 includes breaking the initial communications thread based on a criteria. The criteria includes a user initiated break wherein a user selectively breaks the initial communications thread. Step 112 includes generating new communications threads from the break in the initial communications thread which include a first thread including communications before the break, and a second thread including communications after the break. Optional step 110 includes locally saving the thread break and the new communications threads with respect to a user who initiated the break. Step 124 includes generating a link in each of the first and second threads referring to the other thread such that the initial communications thread is reconstituted when the link is selected. Step 128 includes deleting the initial communications thread after the first and second threads are generated with their respective links.

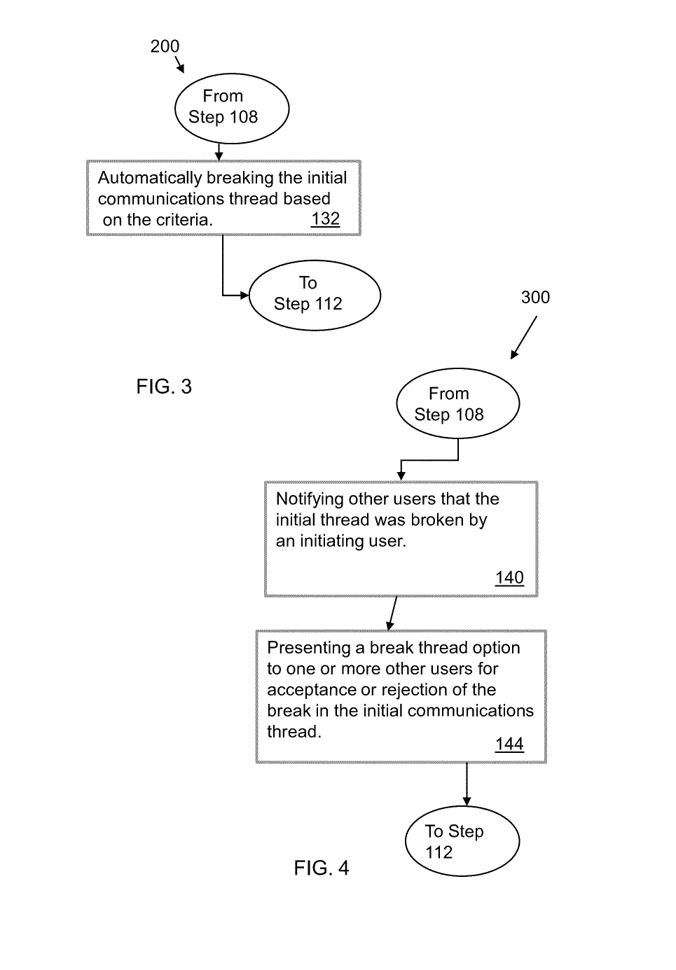

Referring to FIG. 3, an optional method 200 continues from step 108 of the method 100 and includes a step 132 including automatically breaking the initial communications thread based on the criteria. The method 200 then continues to step 112 of the method 100 from step 132.

Referring to FIG. 4, an optional method 300 continues from step 108 of the method 100 and includes step 140 which includes notifying one or more other users that the initial thread was broken by an initiating user. The initiating user is the user who initiated the generation of the thread break. Step 144 includes presenting a break thread option to another user (or a plurality of users) for acceptance or rejection of the break in the initial communications thread. The method 300 then continues to step 112 of the method 100 from step 144.

While embodiments of the present invention has been particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

Therefore, one or more Figures described herein may illustrate a schematic of an embodiment of the disclosure and may include a representative computer system or processing system that may implement a method and a program in one or more embodiments of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with one or more processing systems in the present disclosure may include, but are not limited to, personal computer systems, server computer systems, handheld or laptop devices, multiprocessor systems, microprocessor-based systems, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units, a system memory, and a bus that couples various system components including system memory to processor. Computer system may include a variety of computer system readable media. Such media may be any available media that is accessible by computer system, and it may include both volatile and non-volatile media, removable and non-removable media. System memory 58, shown in FIG. 1, can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices such as a keyboard, a pointing device, a display, etc.; one or more devices that enable a user to interact with computer system; and/or any devices (e.g., network card, modem, etc.) that enable computer system to communicate with one or more other computing devices. Such communication can occur via Input/Output (I/O) interfaces. Additionally, computer systems can communicate with one or more networks such as a local area network (LAN), a general wide area network (WAN), and/or a public network (e.g., the Internet) via network adapter. As depicted, network adapter communicates with the other components of computer system via bus. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

Additionally, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Further, any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams as may be illustrated in the one or more Figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments, features, and instructive examples described above are illustrative, and should not be construed to limit the present disclosure to the particular embodiments or enumerated examples. Thus, various changes and modifications may be effected by one skilled in the art without departing from the spirit or scope of the disclosure as defined in the appended claims.

What is claimed is:

1. A method for breaking a communications thread on a communications system, comprising the steps of:
identifying an initial communications thread between two or more of a plurality of users on a communications system;
breaking the initial communications thread based on a criteria, the criteria including a user initiated break wherein a user selectively breaks the initial communications thread; and
generating new communications threads from the break in the initial communications thread which include a first thread including communications before the break and a second thread including communications after the break, wherein at least one of the above steps is performed using a computer.

2. The method of claim 1, further comprising:
generating a link in each of the first and second threads referring to the other thread such that the initial communications thread is reconstituted when either of the links are selected.

3. The method of claim 1, wherein the thread break and the new communications thread are saved locally with respect to a user which initiated the break.

4. The method of claim 1, wherein the initial communications thread is broken into a plurality of new threads each of which include a link.

5. The method of claim 1, further comprising:
notifying other users that the initial thread was broken by an initiating user.

6. The method of claim 1, further comprising:
presenting a break thread option to another user for acceptance or rejection of the break in the initial communications thread.

7. The method of claim 1, further comprising:
presenting a break thread option to multiple users for acceptance or rejection of the break thread option for the initial communications thread, the break thread option being individually applied for each of the multiple users.

8. The method of claim 1, further comprising:
presenting a break thread option to multiple users for acceptance or rejection of the break thread option for the initial communications thread, the break thread option being applied based on a majority vote by the multiple users.

9. The method of claim 1, further comprising:
automatically breaking the initial communications thread based on the criteria.

10. The method of claim 1, wherein the criteria includes a plurality of break thread options including breaking the initial thread at a specific message.

11. The method of claim 1, wherein the initial communications thread includes an email communication.

12. The method of claim 1, wherein the criteria includes multiple break thread options, and the method further comprising:
automatically breaking the initial communications thread by selecting a break thread option;
presenting the break thread option to a user for acceptance or rejection by the user.

13. The method of claim 1, wherein an initiating user selects a break point in the initial communications thread for breaking the thread.

14. The method of claim 1, wherein an initiating user selects a break point in the initial communications thread for breaking the thread before sending a new thread based on the initial communications thread to another user.

15. The method of claim 1, wherein a user sets one or more rules for breaking the initial thread, and another user accepts or rejects the rules.

16. The method of claim 1, wherein the criteria includes breaking the initial communications thread based on: a context change of the thread; a change in a recipient of the thread; exceeding a threshold time of the thread; or exceeding a threshold length of the thread.

17. The method of claim 2, further comprising:
deleting the initial communications thread after the step of generating a link in each of the first and second threads referring to the other thread.

18. A system for breaking a communications thread on a communications system, comprising:
an initial communications thread between two or more of a plurality of users on a communications system being identifiable by a program embodied on a computer readable storage device and being executable by a processor of a computer;
a criteria for breaking the initial communications thread, the criteria including a user initiated break wherein a user selectively breaks the initial communications thread; and
new communications threads generated from the break in the initial communications thread which include, a first thread including communications before the break and a second thread including communications after the break.

19. The system of claim 18, further comprising:
a link generated in each of the first and second threads referring to the other thread such that the initial communications thread is reconstituted when either of the links are selected.

20. The system of claim 18, wherein an initiating user selects a break point in the initial communications thread for breaking the thread before sending a new thread based on the initial communications thread to another user.

21. The system of claim 18, wherein the criteria includes breaking the initial communications thread based on: a context change of the thread; a change in a recipient of the thread; exceeding a threshold time of the thread; or exceeding a threshold length of the thread.

22. A computer program product for breaking a communications thread on a communications system, the computer program product comprising a computer readable storage medium having program code embodied therewith, the program code being readable/executable by a processor to perform a method, comprising:
identifying an initial communications thread between two or more of a plurality of users on a communications system;
breaking the initial communications thread based on a criteria, the criteria including a user initiated break wherein a user selectively breaks the initial communications thread; and
generating new communications threads from the break in the initial communications thread which include, a first thread including communications before the break and a second thread including communications after the break.

23. The computer program product of claim 22, further comprising:
generating a link in each of the first and second threads referring to the other thread such that the initial communications thread is reconstituted when either of the links are selected.
